(19) United States
(12) Patent Application Publication
(10) Pub. No.: US 2026/0284841 A1
(43) Pub. Date: Sep. 24, 2026

(54) ELECTRIC TOOL

(71) Applicant: PANASONIC CORPORATION, Osaka (JP)

(72) Inventors: Shinji SEKO, Mie (JP); Hidenori SHIMIZU, Shiga (JP); Masaya SATO, Mie (JP)

(21) Appl. No.: 19/480,300

(22) PCT Filed: Mar. 29, 2024
(86) PCT No.: PCT/JP2024/013077

§ 371 Date: Oct. 30, 2025

(30) Foreign Application Priority Data
May 22, 2023 (JP) 2023-084033

(51) Int. Cl. B25B 21/02; B25F 5/00; B25F 5/02

(52) U.S. Cl. CPC B25B 21/02; B25F 5/001; B25F 5/02

(57) ABSTRACT

An electric tool includes an impact mechanism. The impact mechanism includes at least: a drive shaft; a hammer having a hammer body; a striking portion; a hammer spring; and an elastic member sandwiched between the hammer body and the hammer spring.

### TECHNICAL FIELD

The present disclosure generally relates to an electric tool, and more particularly relates to an electric tool for holding a tip tool thereon.

### BACKGROUND ART

An impact screwdriver including a striking mechanism has been known in the art (refer to, for example Patent Literature 1). The striking mechanism described in Patent Literature 1includes: a hammer provided on the outer surface of a spindle; and a coil spring for biasing the hammer forward. The hammer includes a pair of nails on its front surface and is coupled to the spindle by way of a ball fitted into both an outer cam groove formed inside the hammer and an inner cam groove formed on the surface of the spindle. In addition, the back surface of the hammer has a groove of a ring shape, into which the front end of the coil spring is inserted. The rear end of the coil spring abuts on a spring seat provided on the front surface of a carrier portion. The bottom of the groove houses a plurality of balls (which are different from the ball fitted into both the outer cam groove and the inner cam groove) and a washer to receive the front end of the coil spring.

In an impact screwdriver having such a configuration, once its switch is turned ON with its trigger pulled, electric power is supplied to its motor, thus causing its rotary shaft to start rotating and thereby causing the spindle to rotate with a reduced speed. This causes the hammer to rotate as well and thereby causes an anvil to rotate by way of an arm engaged with the nail, thus eventually enabling a bit to fasten a screw. As the torque of the anvil increases while the screw is being fastened more and more tightly, the hammer moves backward by overcoming the biasing force applied by the coil while rolling the ball along with the inner cam groove of the spindle. When the nail leaves the arm, the hammer is caused to start rotating while moving forward by being biased by the coil spring and guided by the inner cam groove, thus bringing the nail into engagement with the arm again and thereby generating rotational striking force (impact) in the anvil. Repeating this procedure allows the screw to be fastened more tightly.

### CITATION LIST

### Patent Literature

Patent Literature 1: JP 2017-035762 A

### SUMMARY OF INVENTION

In the electric tool of Patent Literature 1, the coil spring stretches to cause the hammer to move forward and thereby bring the hammer into collision with the arm of the anvil. At this time, however, the ball inserted into the ring-shaped groove on the back surface of the hammer collides against the bottom of the groove of the hammer, thus producing significant impact and vibration, which is a problem with the known electric tool.

An object of the present disclosure is to provide an electric tool with the ability to reduce the impact and vibration.

An electric tool according to an aspect of the present disclosure includes an impact mechanism. The impact mechanism includes at least: a drive shaft; a hammer having a hammer body; a striking portion; a hammer spring; and an elastic member which is sandwiched between the hammer body and the hammer spring.

### BRIEF DESCRIPTION OF DRAWINGS

FIG. 1 is a perspective view of an electric tool according to an exemplary embodiment;

FIG. 2 is a cross-sectional view of the electric tool;

FIG. 3 is a cross-sectional view illustrating a main part of the electric tool;

FIG. 4 is an exploded perspective view illustrating the main part of the electric tool as viewed from behind the electric tool; and

FIG. 5 is an exploded perspective view illustrating the main part of the electric tool as viewed from in front of the electric tool.

### DESCRIPTION OF EMBODIMENTS

### Embodiment

An electric tool according to an embodiment will be described with reference to the accompanying drawings. Note that the embodiment to be described below is only an exemplary one of various embodiments of the present disclosure and should not be construed as limiting. Rather, the exemplary embodiment may be readily modified in various manners depending on a design choice or any other factor without departing from the scope of the present disclosure. The drawings to be referred to in the following description of embodiments are all schematic representations. Thus, the ratio of the dimensions (including thicknesses) of respective constituent elements illustrated on the drawings does not always reflect their actual dimensional ratio.

### (1) Overview

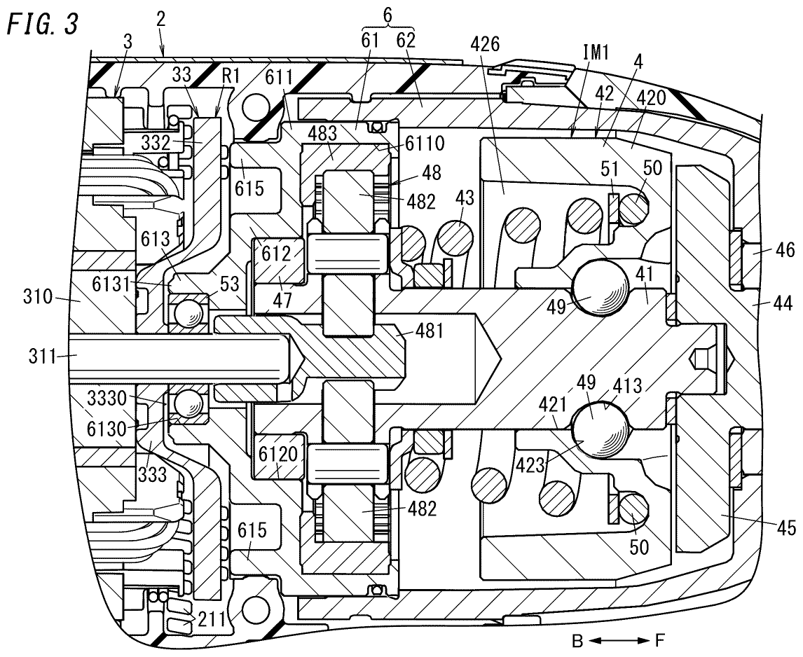

As shown in FIG. 3, an electric tool 1 according to this embodiment includes an impact mechanism IM1. The impact mechanism IM1 includes at least: a drive shaft 41; a hammer 42 having a hammer body 420; a striking portion 45; a hammer spring 43; and an elastic member 50 which is sandwiched between the hammer body 420 and the hammer spring 43.

The electric tool 1 according to this embodiment has the ability to reduce the impact and vibration.

### (2) Details

The electric tool 1 is a portable electric tool which may be gripped by the worker with one of his or her hands.

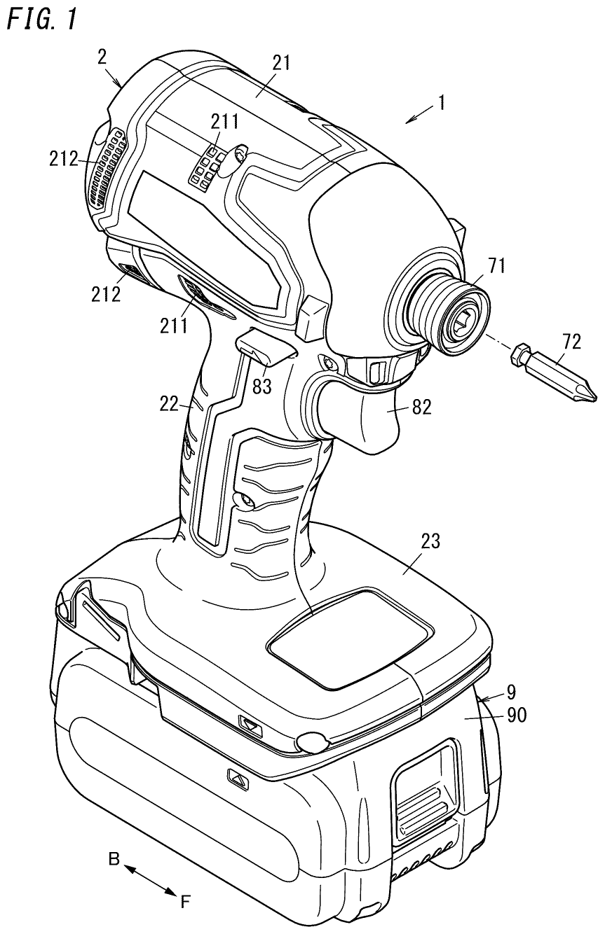

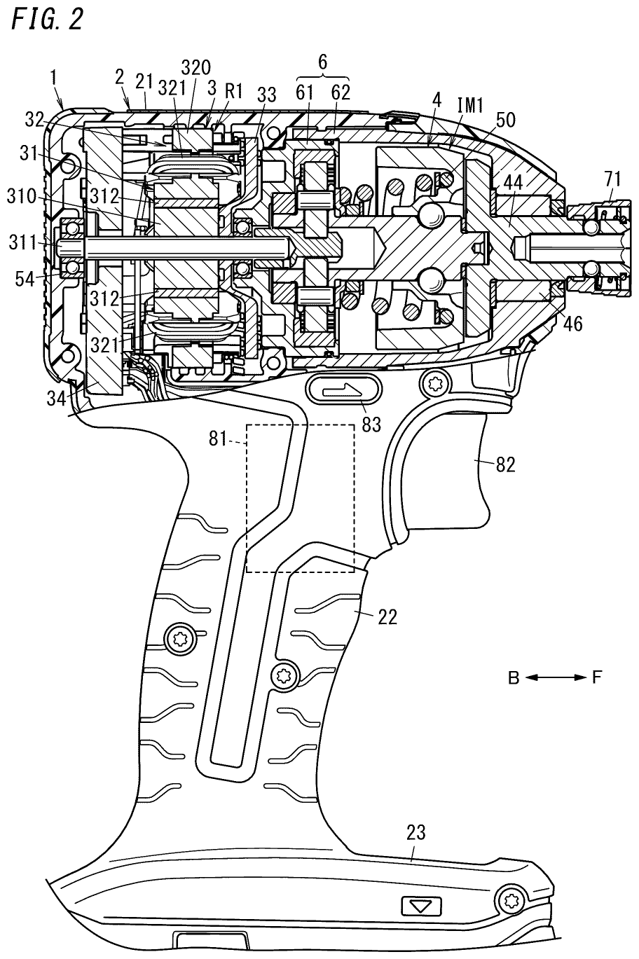

As shown in FIG. 2, the electric tool 1 according to this embodiment includes a motor 3, a transmission mechanism 4, a case 6, and a housing 2. The transmission mechanism 4 transmits the rotational force (torque) of a rotary shaft 311 of the motor 3 to a tip tool 72 (refer to FIG. 1). The case 6 houses the transmission mechanism 4 at least partially. The housing 2 houses the motor 3, the transmission mechanism 4 and the case 6.

The electric tool 1 includes a holder 71 for holding thereon a bit (such as a screwdriver bit) serving as the tip tool 72. The tip tool 72 is attached removably onto the holder 71. The transmission mechanism 4 drives the tip tool 72 using the rotational force generated by the motor 3. In the electric tool 1 according to this embodiment, the transmission mechanism 4 includes an impact mechanism IM1. The electric tool 1 according to this embodiment is an electric impact screwdriver allowing the worker to perform the operation of fastening a screw using the striking force applied by the impact mechanism IM1.

A rechargeable battery pack 9 (refer to FIG. 1) is attached removably to the electric tool 1. The electric tool 1 is powered by the battery pack 9. In this embodiment, the battery pack 9 is not a constituent element of the electric tool 1. However, this is only an example and should not be construed as limiting. Alternatively, the electric tool 1 may include the battery pack 9 as a constituent element. The battery pack 9 includes an assembled battery formed by connecting a plurality of secondary batteries (such as lithium-ion batteries) in series, and a battery pack case 90 that houses the assembled battery. The battery pack 9 includes a communications connector for transmitting battery information about the battery pack 9. Examples of the battery information include various pieces of information about the temperature, battery level, rated voltage, rated capacity, and number of times of charging.

As shown in FIGS. 1 and 2, the housing 2 of the electric tool 1 includes a barrel 21, a grip 22, and a base 23. The barrel 21 has the shape of a hollow cylinder. The grip 22 protrudes, in one direction aligned with the radius of the barrel 21, from an outer peripheral surface of the barrel 21.

The grip 22 is formed in the shape of a hollow cylinder elongated in the one direction. The internal space of the grip 22 communicates with the internal space of the barrel 21. The barrel 21 is connected to one longitudinal end of the grip 22 and the base 23 is connected to the other longitudinal end of the grip 22. The battery pack 9 is attached removably to the base 23.

As shown in FIG. 2, the electric tool 1 further includes a switch circuit module 81, an operating member 82, and a forward/reverse switch 83. The electric tool 1 further includes a control circuit module.

The switch circuit module 81 is disposed in the internal space of the grip 22. The switch circuit module 81 is connected to the control circuit module. The control circuit module is housed in the base 23.

The switch circuit module 81 includes a main switch. The main switch is used to open or close a power supply path for supplying electric power from the battery pack 9 to the motor 3. The operating member 82 is a trigger lever to be operated by the user of the electric tool 1 with one of his or her fingers. The operating member 82 is operatively coupled to the switch circuit module 81. The operating member 82 is pulled toward the grip 22 when operated by the user with one of his or her fingers.

The switch circuit module 81 turns the main switch OFF when the operating member 82 is pulled to a depth equal to or less than a predetermined value but turns the main switch ON when the operating member 82 is pulled to a depth greater than the predetermined value. This allows the switch circuit module 81 to selectively supply or cut off electric power from the battery pack 9 to the motor 3. In addition, when the operating member 82 is pulled to a depth greater than the predetermined value, the switch circuit module 81 also transmits an operating signal, corresponding to the depth to which the operating member 82 has been pulled, to the control circuit module. This causes the magnitude of the electric power supplied to the motor 3 to vary according to the depth to which the operating member 82 has been pulled, thus changing the rotational velocity of the rotary shaft 311 of the motor 3.

In addition, the switch circuit module 81 is also connected to the forward/reverse switch 83. The forward/reverse switch 83 is a direction switch allowing the user to change the rotational direction of the rotary shaft 311 of the motor 3. The forward/reverse switch 83 is provided in the vicinity of the boundary between the barrel 21 and the grip 22.

The control circuit module is connected to the switch circuit module 81 and the motor 3. With the battery pack 9 attached to the electric tool 1, the control circuit module is connected to a pair of power terminals and the communications connector of the battery pack 9. This allows the control circuit module to be supplied with electric power from the battery pack 9 via the pair of power terminals. In addition, the control circuit module acquires the battery information from the battery pack 9 via the communications connector. Furthermore, the control circuit module controls the motor 3 in accordance with an operating signal supplied from the switch circuit module 81. More specifically, the control circuit module controls the rotational velocity, rotational direction, and other parameters of the rotary shaft 311 of the motor 3.

The motor 3 is a brushless motor. The motor 3 includes a rotor 31 and a stator 32. The rotor 31 includes a rotor body 310, the rotary shaft 311, and a plurality of permanent magnets 312. The stator 32 includes a stator body 320 and a plurality of coils 321.

The rotor body 310 is a rotor core made of a magnetic material. The rotary shaft 311 and the plurality of permanent magnets 312 are held by the rotor body 310. The rotary shaft 311 and the plurality of permanent magnets 312 rotate along with the rotor body 310.

The stator body 320 is a stator core made of a magnetic material. The stator body 320 is disposed around the rotor body 310. That is to say, the stator body 320 surrounds the rotor body 310. The plurality of coils 321 are wound around the stator body 320.

The rotor 31 rotates with respect to the stator 32. That is to say, when the magnetic flux generated from the plurality of coils 321 is applied to the plurality of permanent magnets 312, the rotor 31 rotates. The rotational force (driving force) of the rotor 31 is transmitted from the rotary shaft 311 to the transmission mechanism 4.

The electric tool 1 includes a fan 33 and a driver circuit module 34. The fan 33 and the driver circuit module 34 are housed in the housing 2. More specifically, the fan 33 and the driver circuit module 34 are housed in the barrel 21 of the housing 2.

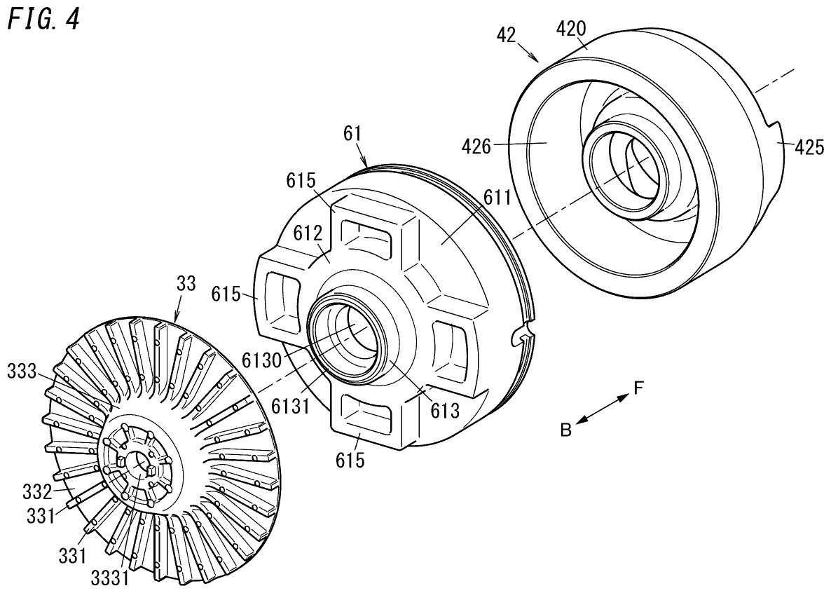

As shown in FIGS. 3 and 4, the fan 33 includes a plurality of blades 331, an annular portion 332, and a hub 333. The hub 333 has the shape of a bottomed cylinder. The bottom surface 3330 of the hub 333 has a through hole 3331, through which the rotary shaft 311 of the motor 3 is passed. The hub 333 is coupled to the rotary shaft 311 of the motor 3. This allows the fan 33 to rotate along with the rotary shaft 311 and the rotor body 310.

The annular portion 332 has the shape of an annular plate in plan view. The hub 333 protrudes from an inner edge of the annular portion 332 toward the rotor body 310. The plurality of blades 331 protrude from the surface of the annular portion 332 (i.e., the surface facing the rotor body 310) toward the rotor body 310. The plurality of blades 331 are arranged radially.

The driver circuit module 34 shown in FIG. 2 is controlled by the control circuit module to drive the motor 3. The driver circuit module 34 includes a circuit board, a plurality of transistors mounted on the circuit board, and an encapsulant that encapsulates the circuit board and the plurality of transistors together.

Along the (longitudinal) axis of the rotary shaft 311, arranged in this order are the driver circuit module 34, the rotor body 310, the fan 33, and the transmission mechanism 4.

The housing 2 houses the motor 3 and the transmission mechanism 4 therein. The housing 2 further houses the case 6. More specifically, the motor 3, the transmission mechanism 4, and the case 6 are housed in the barrel 21 of the housing 2. The barrel 21 has a plurality of vents 211, 212 (refer to FIG. 1). The vents 211, 212 are provided at a position where the vent 211, 212 faces a rotator R1 and/or a position where the vent 211, 212 is located opposite from the transmission mechanism 4 with respect to the rotator R1 (i.e., located closer to the driver circuit module 34 than to the transmission mechanism 4 with respect to the rotator R1). In this embodiment, a plurality of vents 211 are provided to face the rotator R1 and a plurality of vents 212 are provided opposite from the transmission mechanism 4 with respect to the rotator R1.

As shown in FIG. 3, the transmission mechanism 4 includes a drive shaft 41, a hammer 42, a hammer spring 43, a spindle 44, a striking portion 45, a first bearing 46, a second bearing 47, a planetary gear mechanism 48, and two steel spheres 49.

The rotary shaft 311 of the motor 3 is coupled to the planetary gear mechanism 48. The rotational force of the rotary shaft 311 of the motor 3 is transmitted to the drive shaft 41 via the planetary gear mechanism 48. The impact mechanism IM1 of the transmission mechanism 4 includes the drive shaft 41, the hammer 42, the hammer spring 43, the spindle 44, the striking portion 45, and the two steel spheres 49. The rotational force of the rotary shaft 311 of the motor 3 is transmitted by the impact mechanism IM1 to the spindle 44. The tip of the spindle 44 also serves as a part of the holder 71 (refer to FIG. 2).

The distance between the motor 3 and the second bearing 47 is shorter than the distance between the motor 3 and the first bearing 46. The drive shaft 41 is supported rotatably by the second bearing 47. The spindle 44 is supported rotatably by the first bearing 46. The drive shaft 41 is coupled to the spindle 44. Thus, the spindle 44 rotates along with the drive shaft 41.

The hammer 42 has a hammer body 420. The hammer body 420 has a through hole 421, through which the drive shaft 41 is passed. The hammer body 420 has a groove 423 on an inner peripheral surface of the through hole 421. The two steel spheres 49 are interposed between the groove 423 and a groove 413 provided on the outer peripheral surface of the drive shaft 41. As the two steel spheres 49 roll inside the groove 413, the hammer 42 is not only movable along the axis of the drive shaft 41, but also rotatable, with respect to the drive shaft 41. In the transmission mechanism 4, as the hammer 42 rotates with respect to the drive shaft 41, the hammer 42 moves along the axis of the drive shaft 41 either toward the spindle 44 or away from the spindle 44 according to the angle of the rotation of the hammer 42.

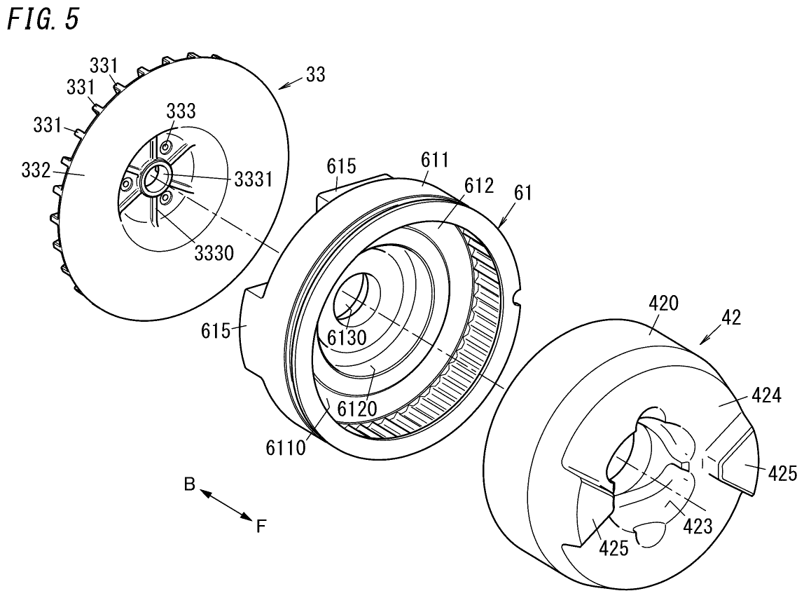

The hammer 42 has two projections 425 (refer to FIG. 5) protruding from a surface 424 (refer to FIG. 5), facing the spindle 44, of the hammer body 420. The hammer body 420 has a circular columnar shape. The two projections 425 are arranged at generally regular intervals along the circumference of the hammer body 420. The two projections 425 may strike the striking portion 45 (i.e., may collide against the striking portion 45). When viewed from one axial end of the drive shaft 41, each of the two projections 425 has a fan shape. The striking portions 45 are formed integrally with the spindle 44.

The hammer body 420 has a groove 426 of a ring shape which is open backward. The groove 426 houses the hammer spring 43, the elastic member 50 and a plate member 51.

The hammer spring 43 is interposed between the hammer 42 and the planetary gear mechanism 48. The hammer spring 43 may be a conical coil spring, for example. The hammer spring 43 has at least its frontend portion housed in the groove 426 to push the bottom of the groove 426 of the hammer body 420 forward.

The impact mechanism IM1 includes the elastic member 50 which is sandwiched between the hammer body 420 and the hammer spring 43. In this embodiment, the impact mechanism IM1 further includes the plate member 51 having a ring shape which is sandwiched between the hammer 42 and the hammer spring 43.

The elastic member 50 is formed as a member which has a smaller elastic modulus than a metal. The elastic member 50 may include a metal part. In this embodiment, the elastic member 50 is configured as a ring-shaped member. More specifically, the elastic member 50 is configured as an O-ring.

As a material for the elastic member 50, a type of rubber is preferably used. Particularly, fluororubber is preferably used as a material for the elastic member 50.

The elastic member 50 has a hardness equal to or greater than 85 degrees. As used herein, the “hardness” refers to a hardness defined by the “JIS K6253 Durometer Type A” standard. More preferably, the elastic member 50 has a hardness equal to or greater than 90 degrees.

The elastic member 50 has a squeeze rate equal to or less than 30% when an elastic force of the hammer spring 43 in a most significantly compressed state is applied to the elastic member 50.

In the impact mechanism IM1, every time the drive shaft 41 roughly makes a half turn, the hammer 42 collides against the striking portion 45. After the collision, the drive shaft 41 continues to rotate under the driving force of the motor 3 and the hammer 42 moves away from the spindle 44 while compressing the hammer spring 43. This allows the hammer 42 to go over the striking portion 45 to cause the next collision.

The planetary gear mechanism 48 transforms the rotational velocity and torque of the rotary shaft 311 of the motor 3 into a rotational velocity and torque required for performing the operation of turning a screw. The planetary gear mechanism 48 is a speed reducer. The planetary gear mechanism 48 includes a sun gear 481, two planetary gears 482, and a ring gear 483. The sun gear 481 is coupled to the rotary shaft 311 of the motor 3. The two planetary gears 482 mesh with the sun gear 481 outside of the sun gear 481. The ring gear 483 meshes with, and supports, the two planetary gears 482.

The electric tool 1 further includes another bearing 53 (third bearing) and a fourth bearing 54 (refer to FIG. 2). The distance between the transmission mechanism 4 and the bearing 53 is shorter than the distance between the transmission mechanism 4 and the fourth bearing 54. The bearing 53 and the fourth bearing 54 rotatably support the rotary shaft 311 of the motor 3. The fourth bearing 54 is held by the housing 2.

The case 6 includes an attachment base 61 and a cover 62. The cover 62 is made of an alloy. The cover 62 has a cylindrical shape. The cover 62 surrounds the transmission mechanism 4 at least partially.

The attachment base 61 has electrical insulation properties. The attachment base 61 is made of a synthetic resin. The bearing 53 is attached to the attachment base 61. Inside the attachment base 61, placed is the planetary gear mechanism 48. The attachment base 61 is coupled to the cover 62 to cover one end (facing toward the motor 3) of the cover 62.

As shown in FIGS. 4 and 5, the attachment base 61 has a circular columnar shape. The attachment base 61 is formed to have its outside diameter increased gradually as the distance from the rotor body 310 increases along the axis of the rotary shaft 311 of the motor 3.

The attachment base 61 includes a larger diameter portion 611, a medium diameter portion 612, and a smaller diameter portion 613, of which the outside diameters are different from each other. Out of the larger diameter portion 611, the medium diameter portion 612, and the smaller diameter portion 613, the larger diameter portion 611 has the largest outside diameter and the smaller diameter portion 613 has the smallest outside diameter. Along the axis of the rotary shaft 311 of the motor 3, the smaller diameter portion 613 is located closer to the rotor body 310 than any of the larger diameter portion 611 or the medium diameter portion 612 is, and the larger diameter portion 611 is located more distant from the rotor body 310 than any of the medium diameter portion 612 or the smaller diameter portion 613 is. The larger diameter portion 611, the medium diameter portion 612, and the smaller diameter portion 613 have the shapes of concentric bottomed cylinders. The larger diameter portion 611 has a through hole 6110, the medium diameter portion 612 has a through hole 6120, and the smaller diameter portion 613 has a through hole 6130. These three through holes 6110, 6120, 6130 communicate with each other. The rotary shaft 311 is passed through the through holes 6110, 6120, 6130.

In addition, the attachment base 61 further has a plurality of (e.g., four in the example illustrated in FIG. 4) projections 615. The plurality of projections 615 are arranged at regular intervals along the circumference of the medium diameter portion 612. The plurality of projections 615 are continuous with the medium diameter portion 612.

As shown in FIG. 3, the bearing 53 that supports the rotary shaft 311 is disposed inside the through hole 6130 of the smaller diameter portion 613. The outside diameter of the bearing 53 is approximately equal to the inside diameter of the through hole 6130.

The smaller diameter portion 613 has a raised portion 6131 at one end thereof opposite from the medium diameter portion 612. The smaller diameter portion 613 protrudes, at the raised portion 6131, toward the rotor body 310. The raised portion 6131 has a ring shape (more specifically, an annular shape).

The second bearing 47 that supports the drive shaft 41 is disposed inside the through hole 6120 of the medium diameter portion 612. The outside diameter of the second bearing 47 is approximately equal to the inside diameter of the through hole 6120.

The ring gear 483 of the planetary gear mechanism 48 is held by the attachment base 61. The ring gear 483 is insert-molded with respect to the attachment base 61. Thus, the ring gear 483 is fixed to the attachment base 61. The ring gear 483 is disposed inside the through hole 6110 of the larger diameter portion 611.

### (3) Lubricant

A lubricant is applied to, for example, the planetary gear mechanism 48, the hammer 42, and other members of the transmission mechanism 4. Thus, the lubricant is housed in the case 6. The lubricant is used to reduce the friction and abrasion, for example, of the transmission mechanism 4. The lubricant has electrical insulation properties. The lubricant may be a semisolid lubricant, for example. More specifically, the lubricant may be a synthetic hydrocarbon oil grease.

### (4) Advantages

With the elastic member 50 provided, it is the elastic member 50, not a metallic member, that collides against the bottom of the groove 426 of the hammer body 420. Therefore, even in the case that impact force is applied between the hammer body 420 and the hammer spring 43, the bottom of the groove 426 of the hammer body 420 does not directly contact with the hammer spring 43, thus reducing the chances of causing significant impact and vibration due to collision between metallic members. Consequently, the impact and vibration are reduced compared to a situation where a steel sphere is used instead of the elastic member 50.

Providing the plate member 51 allows (the hammer body 420 of) the hammer 42 to rotate relative to the plate member 51, thus making it easier for the hammer 42 to rotate with respect to the hammer spring 43. The hammer 42 receives, from the hammer spring 43, the force applied toward the striking portion 45 in a direction along the axis of the drive shaft 41.

Forming the elastic member 50 in a ring shape prevents, with reliability, the collision between the hammer spring 43 and the bottom of the groove 426, no matter how the hammer spring 43 rotates with respect to the hammer 42.

The elastic member 50 is housed in the groove 426, which reduces the chances of the elastic member 50 being displaced from its predetermined position.

The elastic member 50 is made of fluororubber, thus reducing the degree of deterioration of the elastic member 50.

The elastic member 50 has a hardness equal to or greater than 85 degrees, which ensures a sufficient degree of rigidity for the elastic member 50. In addition, this may reduce the effect on the operations of the hammer 42 and the striking portion 45 compared to the case that a steel sphere is used instead of the elastic member 50.

The elastic member 50 has a squeeze rate equal to or less than 30% when the elastic force of the hammer spring 43 in a most significantly compressed state is applied to the elastic member 50, which ensures sufficient degrees of rigidity and durability for the elastic member 50.

### Variations of Embodiment

Next, variations of the exemplary embodiment will be enumerated one after another. Note that the variations to be described below may be adopted in combination as appropriate.

The electric tool 1 may have no fans 33.

The fan 33 may be disposed behind the rotor body 310. That is to say, the rotor body 310 may be interposed between the fan 33 and the transmission mechanism 4.

The rotator R1 may include not only the rotor body 310 but also an intermediate member as well. The intermediate member is interposed between the rotor body 310 and the transmission mechanism 4 and turns along with the rotor 31. The fan 33 according to the exemplary embodiment is an exemplary intermediate member.

A sealed bearing having a seal to reduce the invasion of foreign particles may also be used as the bearing 53.

The lubricant does not have to be a semisolid lubricant but may also be a liquid lubricant (such as lubricant oil).

The transmission mechanism 4 does not have to have the configuration described above for the exemplary embodiment but may also be a gear mechanism different from the planetary gear mechanism 48. Also, the transmission mechanism 4 does not have to include only gears but may also include a clutch plate, for example.

The electric tool 1 does not have to be an impact screwdriver but may also be an impact wrench, a drill screwdriver, a hammer drill, or a jigsaw, for example.

The tip tool 72 may be attached removably to the holder 71 or may be fixed to the holder 71 integrally, whichever is appropriate.

The elastic member 50 does not have to be configured as an O-ring but may also be configured as a ring-shaped member which has a non-circular cross section such as a D-ring. In addition, the elastic member 50 does not have to be configured as a ring-shaped member. For example, the elastic member 50 may be made up of a plurality of spherical members.

The material of the elastic member 50 is not limited to fluororubber. Alternatively, any of various other types of rubber including silicon rubber and NBR (nitrile butadiene rubber) may also be used. In addition, the material of the elastic member 50 does not have to be rubber. Alternatively, the elastic member 50 may also be made of an elastomer, for example.

The hardness of the elastic member 50 does not have to be equal to or greater than 85 degrees.

The squeeze rate of the elastic member 50 does not have to be equal to or less than 30% when the elastic force of the hammer spring 43 in a most significantly compressed state is applied to the elastic member 50.

### Recapitulation

The foregoing description of embodiments and their variations provides specific implementations for the following aspects of the present disclosure.

An electric tool (1) according to a first aspect includes an impact mechanism (IM1). The impact mechanism (IM1) includes at least: a drive shaft (41); a hammer (42) having a hammer body (420); a striking portion (45); a hammer spring (43); and an elastic member (50) sandwiched between the hammer body (420) and the hammer spring (43).

According to this configuration, impact and vibration are reduced compared to a situation where a steel sphere is used instead of the elastic member (50).

In an electric tool (1) according to a second aspect, which may be implemented in conjunction with the first aspect, the elastic member (50) has a ring shape.

This configuration prevents, with reliability, the collision between the hammer spring (43) and the bottom of a groove (426), no matter how the hammer spring (43) rotates with respect to the hammer (42).

In an electric tool (1) according to a third aspect, which may be implemented in conjunction with the first or second aspect, the hammer body (420) has a groove (426) having a ring shape which is open backward. The elastic member (50) is housed in the groove (426).

This configuration reduces the chances of the elastic member (50) being displaced from its predetermined position (i.e., the groove 426).

An electric tool (1) according to a fourth aspect, which may be implemented in conjunction with any one of the first to third aspects, further includes a plate member (51) having a ring shape between the hammer spring (43) and the elastic member (50).

This configuration makes it easier for the hammer body (420) to rotate with respect to the hammer spring (43).

In an electric tool (1) according to a fifth aspect, which may be implemented in conjunction with any one of the first to fourth aspects, the elastic member (50) is made of fluororubber.

This configuration reduces the degree of deterioration of the elastic member (50).

In an electric tool (1) according to a sixth aspect, which may be implemented in conjunction with any one of the first to fifth aspects, the elastic member (50) has a hardness equal to or greater than 85 degrees.

This configuration reduces the effect on the operations of the hammer (42) and the striking portion (45).

In an electric tool (1) according to a seventh aspect, which may be implemented in conjunction with any one of the first to sixth aspects, the elastic member (50) has a squeeze rate equal to or less than 30% when an elastic force of the hammer spring (43) in a most significantly compressed state is applied to the elastic member (50).

This configuration ensures sufficient degrees of rigidity and durability for the elastic member (50).

Note that the constituent elements according to the second to seventh aspects are not essential constituent elements for the electric tool (1) but may be omitted as appropriate.

### REFERENCE SIGNS LIST

1 Electric Tool
41 Drive Shaft
42 Hammer
420 Hammer Body
426 Groove
43 Hammer Spring
45 Striking Portion
50 Elastic Member
51 Plate Member
IM1 Impact Mechanism

1. An electric tool including an impact mechanism, the impact mechanism comprising at least:
a drive shaft;
a hammer having a hammer body;
a striking portion;
a hammer spring; and
an elastic member sandwiched between the hammer body and the hammer spring.

2. The electric tool of claim 1, wherein
the elastic member has a ring shape.

3. The electric tool of claim 1, wherein
the hammer body has a groove having a ring shape which is open backward, and the elastic member is housed in the groove.

4. The electric tool of claim 1, further comprising a plate member having a ring shape between the hammer spring and the elastic member.

5. The electric tool of claim 1, wherein
the elastic member is made of fluororubber.

6. The electric tool of claim 1, wherein
the elastic member has a hardness equal to or greater than 85 degrees.

7. The electric tool of claim 1, wherein
the elastic member has a squeeze rate equal to or less than 30% when an elastic force of the hammer spring in a most significantly compressed state is applied to the elastic member.
